(19) United States
(12) Patent Application Publication
(10) Pub. No.: US 2024/0029474 A1
(43) Pub. Date: Jan. 25, 2024

(54) PERSON EVALUATION INFORMATION GENERATION METHOD

(71) Applicant: NEC Corporation, Minato-ku, Tokyo (JP)

(72) Inventor: Yusuke OI, Tokyo (JP)

(73) Assignee: NEC Corporation, Minato-ku, Tokyo (JP)

(21) Appl. No.: 18/025,619

(22) PCT Filed: Sep. 16, 2020
(86) PCT No.: PCT/JP2020/035052

§ 371 Date: Mar. 9, 2023

(51) Int. Cl. G06V 40/20

(52) U.S. Cl. CPC G06V 40/20

(57) ABSTRACT

A person evaluation information generation device 100 of the present invention includes an acquisition unit 121 that acquires video data and audio data related to a plurality of persons, and generates speech and motion information related to the plurality of persons on the basis of the video data and the audio data of each of the plurality of persons, a generation unit 122 that generates evaluation information in which speech and motion information acquired from at least one person to be evaluated and speech and motion information acquired from at least another person, among the speech and motion information of the plurality of persons, are associated with each other, and an output unit 123 that outputs the evaluation information.

### TECHNICAL FIELD

The present invention relates to a person evaluation information generation method, a person evaluation information generation device, and a program.

### BACKGROUND ART

In recent years, due to advances in communication technology, face-to-face work such as meetings and interviews by a plurality of persons can be conducted over a network. As a result, persons can conduct face-to-face work such as meetings and interviews without gathering in a specific place such as a conference room, which enables reduction of temporal and economical costs for infection control measures and traveling of persons. For example, Patent Literature 1 discloses a system for conducting an interview online. In Patent Literature 1, from image data of an interview participant, the interview participant is evaluated by means of analysis of the size of gestures and hand gestures and the number of times of nodding, and analysis of the degree of interest based on the size, color, brightness, and the like of the pupil.

### CITATION LIST

Patent Literature 1: JP 2017-219989 A

### SUMMARY

### Technical Problem

However, in Patent Literature 1, since a specific interview participant is evaluated based on the information acquired from the video data of the specific interview participant, it may be difficult to perform evaluation while taking into account how the specific interview participant interacts with other persons (for example, interviewers and other interviewees).

In view of the above, an object of the present invention is to provide a person evaluation information generation method capable of solving the above-described problem, that is, it is difficult to appropriately evaluate a specific person.

### Solution to Problem

A person evaluation information generation method, according to one aspect of the present invention, is configured to include

acquiring video data and audio data related to a plurality of persons;

generating speech and motion information related to the plurality of persons on the basis of the video data and the audio data of each of the plurality of persons;

generating evaluation information in which speech and motion information acquired from at least one person to be evaluated and speech and motion information acquired from at least another person, among the speech and motion information of the plurality of persons, are associated with each other; and

outputting the evaluation information.

Further, a person evaluation information generation device, according to one aspect of the present invention, is configured to include

an acquisition unit that acquires video data and audio data related to a plurality of persons, and generates speech and motion information related to the plurality of persons on the basis of the video data and the audio data of each of the plurality of persons;

a generation unit that generates evaluation information in which speech and motion information acquired from at least one person to be evaluated and speech and motion information acquired from at least another person, among the speech and motion information of the plurality of persons, are associated with each other; and

an output unit that outputs the evaluation information.

Further, a program according to one aspect of the present invention, is configured to cause an information processing device to execute processing to:

acquire video data and audio data related to a plurality of persons;

generate speech and motion information related to the plurality of persons on the basis of the video data and the audio data of each of the plurality of persons;

generate evaluation information in which speech and motion information acquired from at least one person to be evaluated and speech and motion information acquired from at least another person, among the speech and motion information of the plurality of persons, are associated with each other; and

output the evaluation information.

### Advantageous Effects of Invention

With the configuration described above, the present invention is able to evaluate a specific person appropriately in view of the situation where a plurality of persons participate in a meeting.

### BRIEF DESCRIPTION OF DRAWINGS

FIG. 1 illustrates the overall configuration of an information processing system according to a first exemplary embodiment of the present invention.

FIG. 2 is a block diagram illustrating a configuration of the information processing device disclosed in FIG. 1.

FIG. 3 illustrates a state of processing by the information processing device disclosed in FIG. 1.

FIG. 4 illustrates a state of processing by the information processing device disclosed in FIG. 1.

FIG. 5 illustrates a state of processing by the information processing device disclosed in FIG. 1.

FIG. 6 is a flowchart illustrating an operation of the information processing device disclosed in FIG. 1.

FIG. 7 is a diagram illustrating another configuration of the information processing system disclosed in FIG. 1.

FIG. 8 illustrates a state of processing by the information processing device disclosed in FIG. 7.

FIG. 9 is a block diagram illustrating a hardware configuration of an information processing device according to a second exemplary embodiment of the present invention.

FIG. 10 is a block diagram illustrating a configuration of the information processing device according to the second exemplary embodiment of the present invention.

FIG. 11 is a flowchart illustrating an operation of the information processing device according to the second exemplary embodiment of the present invention.

### DESCRIPTION OF EMBODIMENTS

### First Exemplary Embodiment

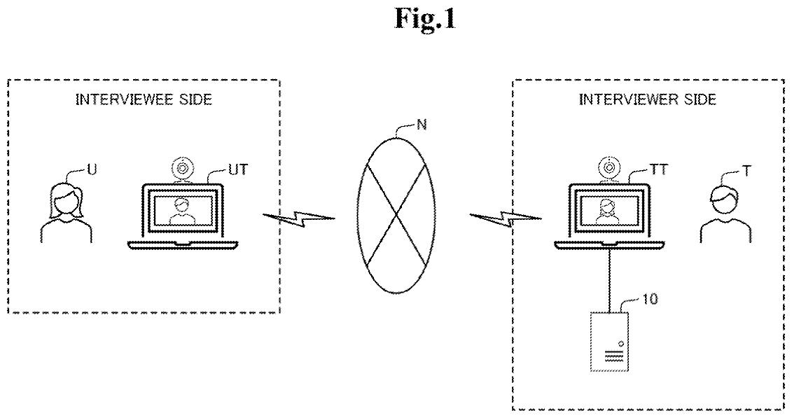

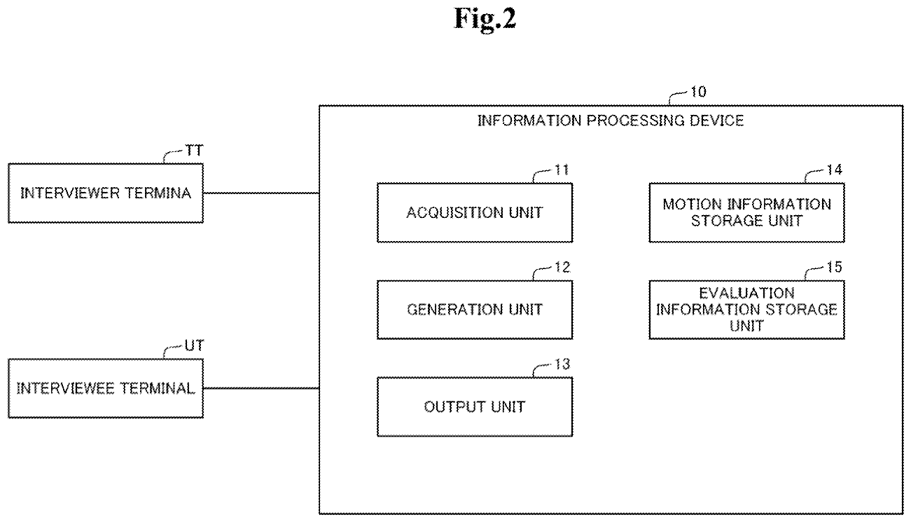

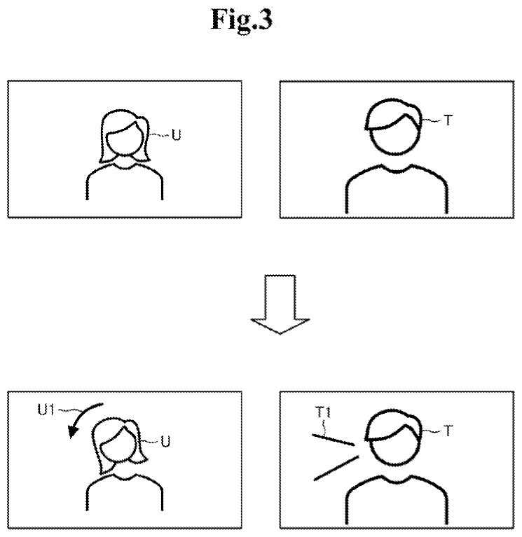

A first exemplary embodiment of the present invention will be described with reference to FIGS. 1 to 8. FIGS. 1 and 2 are diagrams for explaining a configuration of an information processing system, and FIGS. 3 to 8 are illustrations for explaining processing operations of the information processing system.

[Configuration]

An information processing system according to the present invention is a system for conducting an interview between an interviewer T and an interviewee U online. In particular, the information processing system is a system for generating evaluation information for evaluating the interviewee U during the interview. In the below description, the case where an interview is conducted between the interviewer T and the interviewee U one-on-one will be provided as an example. However, the number of the interviewers T and/or the interviewees U may be plural. Further, the information processing system of the present invention is not limited to be used when the interviewer T and the interviewee U conduct an interview. It may be used to generate person evaluation information of a specific person or a plurality of persons during a meeting such as a conference by a plurality of persons.

As illustrated in FIG. 1, in the information processing system of the present disclosure, an interviewer terminal TT operated by the interviewer T and an interviewee terminal UT operated by the interviewee U are connected to each other over a network N. Each of the interviewer terminal TT and the interviewee terminal UT is an information processing terminal such as a laptop personal computer or a smartphone, and is equipped with a photographing device such as a camera and a sound collecting device such as a microphone. Each of the interviewer terminal TT and the interviewee terminal UT has a function of transmitting and outputting at least one of captured video information and collected audio information to the other party's information processing terminal. In other words, the interviewee terminal UT displays video information in which the interviewer T captured by the interviewer terminal TT is shown, and outputs audio information such as speech by the interviewer T collected by the interviewer terminal TT. Further, the interviewer terminal TT displays video information in which the interviewee U captured by the interviewee terminal UT is shown, and outputs audio information such as speech by the interviewee U collected by the interviewee terminal UT.

As illustrated in FIG. 1, the information processing system also includes an information processing device 10 provided to the interviewer side. The information processing device 10 is connected to the interviewer terminal TT over a network such as a private LAN of the company to which the interviewer T belongs. The information processing device 10 is configured to acquire, from the interviewer terminal TT, interview information including video information (video data) and audio information (audio data) representing the state of an interview conducted between the interviewer T and the interviewee U online, and generate evaluation information for evaluating the interviewee U. Hereinafter, a configuration of the information processing device 10 will be described in detail.

The information processing device 10 is configured of one or a plurality of information processing devices each having an arithmetic device and a storage device. As illustrated in FIG. 2, the information processing device 10 includes an acquisition unit 11, a generation unit 12, and an output unit 13. The functions of the acquisition unit 11, the generation unit 12, and the output unit 13 can be realized through execution, by the arithmetic device, of a program for realizing the respective functions stored in the storage unit. The information processing device 10 also includes a motion information storage unit 14 and an evaluation information storage unit 15. Each of the motion information storage unit 14 and the evaluation information storage unit 15 is configured of a storage device.

The acquisition unit 11 acquires, from the interviewer terminal TT, interview information including video information and audio information captured and collected by the interviewer terminal TT. The acquisition unit 11 also acquires, from the interviewer terminal TT, interview information including video information and audio information of an interviewee U to be evaluated (person to be evaluated) that is transmitted from the interviewee terminal UT over the network N and acquired by the interviewer terminal TT. However, the acquisition unit 11 may acquire interview information of the interviewee U from the interviewee terminal UT over the network N. To the acquired interview information, time information is given. Time information is, for example, elapsed time from the interview start time, but is not limited thereto.

Then, the acquisition unit 11 analyzes the acquired interview information including the video information and the audio information, acquires motion information related to the motion of the interviewer T and the interviewee T, and stores the motion information in the motion information storage unit 14 in association with the interview information including the video information and the audio information. The motion information may include the contents of speech of the interviewer T and the interviewee U. In the below description, when the motion information includes the contents of speech, the “motion information” may be referred to as “speech and motion information” For example, from the interview information of the interviewer T, the acquisition unit 11 analyzes the audio information spoken by the interviewer T included in the interview information, and acquires text information representing the words spoken by the interviewer T as interviewer motion information. As an example, the acquisition unit 11 acquires words such as “The question is . . . ” and “Please express your opinion on . . . ”. Moreover, from the interview information of the interviewee U, the acquisition unit 11 analyzes the body motion, that is, behavior, of the interviewee U from the video information included in the interview information, and acquires text related to the motion of the interviewee U as interviewee motion information. As examples, the interviewee motion information includes “tilt his/her head”, “nod”, “touch his/her hair”, “look down”, and “become silent”. The acquisition unit 11 may store the acquired interviewer motion information and interviewee motion information in association with the time information at which such motion was performed in the interview information, to thereby store them in association with the corresponding part in the interview information from which the interviewer motion information and the interviewee motion information are extracted.

Here, the acquisition unit 11 acquires text specifying the motion of the interviewee U from the video information by using, for example, a technique called video bidirectional encoder representations from transformers (Video BERT). An exemplary operation of the Video BERT includes a process of extracting behavior from the video and generating text representing the behavior. For example, the acquisition unit 11 may acquire, from the video information and audio information included in the interview information, text representing the behavior of the interviewee U and text representing the words spoken by the interviewee U as interviewee motion information. However, the acquisition unit 11 may acquire text related to the motion from the video information by a method other than that described above. Further, while the acquisition unit 11 acquires text information representing the words spoken by the interviewer T as interviewer motion information from the interview information of the interviewer T in the above description, the acquisition unit 11 may acquire text related to the motion of the interviewer T from the video information of the interviewer T as interviewer motion information.

Here, another example of motion information acquired by the acquisition unit 11 will be described. For example, motion information may include interviewer motion information of the interviewer T, and words and behavior, expression, line of sight, voice volume, voice tone, emotion, grooming, temperature, and the like of each of the interviewees U. The acquisition unit 11 may also acquire specific motion of a person, for example, as hand motion, specific motion that may appear when the person is nervous such as touching the face and touching the hear, as motion information.

The generation unit 12 generates evaluation information by extracting, from the interviewer motion information and the interviewee motion information stored in the motion information storage unit 14, pieces of corresponding information and associate them with each other, and stores them in the evaluation information storage unit 15. At that time, first, from the interviewer motion information, the generation unit 12 extracts interviewer motion information corresponding to a previously set motion. For example, from the interviewer motion information, the generation unit 12 extracts interviewer motion information consisting of text information including specific words. As an example, as interviewer motion information, the generation unit extracts interviewer motion information consisting of a sentence following the words “the question is”, like “The question is . . . ”. Then, the generation unit 12 extracts interviewee motion information specifying a motion of the interviewee U corresponding to the motion of the interviewer T represented by the extracted interviewer motion information. For example, the generation unit 12 specifies time information at which the motion of the interviewer T represented by the extracted interviewer motion information was performed, and extracts interviewee motion information specifying the motion of the interviewee U performed immediately after the time. As an example, as the interviewee motion information, a motion “tilt his/her head” is extracted.

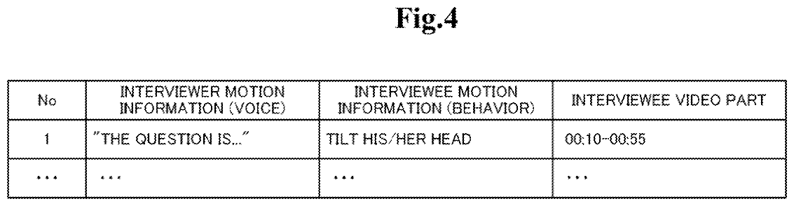

FIG. 3 illustrates an example of interview information including video information and audio information at the time of an interview between the interviewer T and the interviewee U. As denoted by a reference sign T1 in the lower drawing of FIG. 3, the generation unit 12 extracts interviewer motion information consisting of text information including a specific word spoken by the interviewer T, and as interviewee motion information corresponding thereto, as denoted by a reference sign Ul in the lower drawing of FIG. 3, extract interviewee motion information representing the motion of the interviewee U performed immediately after the speech of the interviewer T. Then, the generation unit 12 generates evaluation information in which the extracted interviewer motion information and interviewee motion information are associated with each other, and stores it in the evaluation information storage unit 15 as illustrated in FIG. 4. At that time, the generation unit 12 associates the interviewer motion information and the interviewee motion information with time information specifying a part in the interview information consisting of video information and audio information, from which the interviewer motion information and the interviewee motion information are extracted, and stores them. Thereby, the video information and the extracted interviewer motion information and interviewee motion information are associated with each other. As described above, in the case where the interviewer motion information acquired by the acquisition unit 11 is text information representing the motion of the interviewer T, the text information as the interviewer motion information representing the motion of the interviewer T is associated with the interviewee motion information that is text information representing the corresponding motion of the interviewee U.

Note that as evaluation information, the generation unit 12 may generate the information while including the evaluation result of the interviewee U based on such evaluation information. The evaluation information may include an evaluation result. That is, the generation unit 12 may associate the interviewee motion information for evaluating the interviewee U with information representing the evaluation result based on the interviewee motion information. For example, the evaluation result may be information generated by any method such as information representing the evaluation result having been evaluated and input by the interviewer T or information representing the evaluation result calculated by a program having been set from the interviewee motion information or the like.

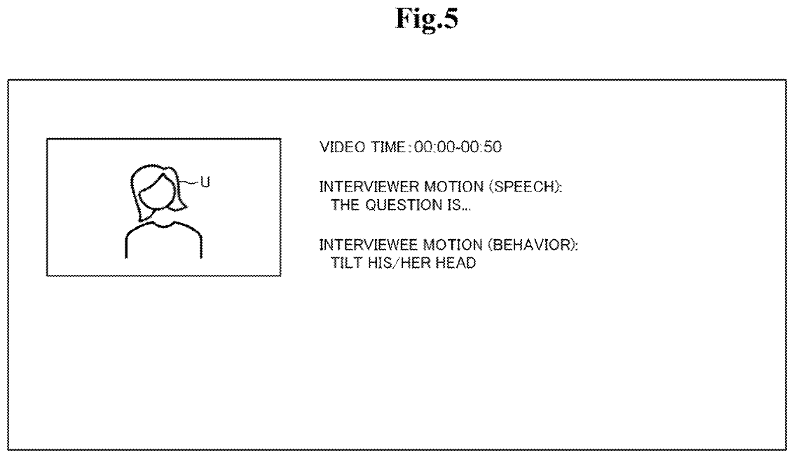

The output unit 13 outputs information generated by the generation unit 12 from the interviewer terminal TT or another information processing terminal. Note that the output unit 13 may control the interviewer terminal TT or another information processing terminal so as to output information generated by the generation unit 12. For example, the output unit 13 outputs interview information including video information and audio information of the interviewee U corresponding to the time information stored in the evaluation information storage unit 15, and evaluation information consisting of text information that is the interviewer motion information and the interviewee motion information associated with such interview information to display them. As an example, as illustrated in FIG. 5, the output unit 13 displays the text “the question is . . . ” related to the audio information spoken by the interviewer T and the text “tilt his/her head”, corresponding thereto, related to the motion (behavior) of the interviewee immediately after temporarily, and also displays interview information including the video information and the audio information of the interviewee U of this interview. In addition to the display illustrated in FIG. 5, the output unit 13 may also display interview information consisting of the video information and the audio information of the interviewer T. In addition to the display illustrated in FIG. 5, the output unit 13 may also display various types of information related to the interviewee U, for example, information representing the results of an aptitude test or a predetermined test taken by the interviewee U before and after the interview. The output unit 13 may display and output information representing the evaluation result included in the evaluation information. While the case of outputting interview information including video information and audio information has been describe above, the output unit 13 may display and output evaluation information consisting of text that is interviewer motion information and interviewee motion information associated with each other.

Here, the information processing device 10 may include a learning unit and an evaluation unit, although not illustrated. For example, the learning unit performs learning by using, as learning data, success/failure information and an evaluation value that are interview results of the interviewee U as information of the past interviews, in addition to the interviewer motion information and the interviewee motion information described above. That is, the learning unit receives the interviewer motion information and the interviewee motion information as input values, and from such input values, generates a model for outputting success/failure or an evaluation value of the interview. At that time, as information of the interviewee U, the learning unit may receive information representing a result of an aptitude test or a predetermined test taken by the interviewee U as input together with the interviewer motion information and the interviewee motion information, and generate a learning model for outputting an interview result or an evaluation value with respect to such input values. Then, the evaluation unit inputs, to the generated model, information including interviewer motion information and interviewee motion information of a new interviewee U to predict success/failure or an evaluation value of the interview with the interviewee U.

[Operation]

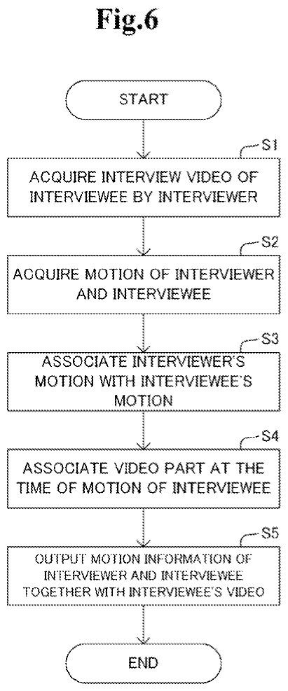

Next, operation of the information processing device 10 described above will be explained with mainly reference to the flowchart of FIG. 6. First, the information processing device 10 acquires interview information including video information and audio information in which the state of an interview between the interviewer T and the interviewee U is shown (step S1). Then, the information processing device 10 analyzes the interview information including the video information and the audio information to generate/extract motion information related to the motion of the interviewer T and the interviewee U (step S2). For example, from the interview information of the interviewer T, the information processing device 10 analyzes the audio information spoken by the interviewer T included in the interview information, and generates the text representing the words spoken by the interviewer T as interviewer motion information. Moreover, from the interview information of the interviewee U, the information processing device 10 analyzes the body motion, that is, behavior, of the interviewee U from the video information included in the interview information, and generates the text related to the motion of the interviewee U as interviewee motion information.

Then, from among the interviewer motion information and the interviewee motion information generated as described above, the information processing device 10 extracts pieces of corresponding information and associate them with each other (step S3). At that time, first, from the interviewer motion information, the information processing device 10 extracts interviewer motion information corresponding to a previously set motion. For example, from the interviewer motion information, the information processing device 10 extracts interviewer motion information including text related to a specific word. Then, the information processing device 10 extracts interviewee motion information specifying a motion of the interviewee U corresponding to the motion of the interviewer T represented by the extracted interviewer motion information. For example, the information processing device 10 specifies time information at which the motion of the interviewer T represented by the extracted interviewer motion information was performed, and extracts interviewee motion information specifying the motion of the interviewee U performed immediately after the time. Then, the information processing device 10 generates evaluation information in which the extracted interviewer motion information and interviewee motion information are associated with each other (step S4). At that time, the information processing device 10 associates the interviewer motion information and the interviewee motion information with time information specifying a part in the interview information including video information and audio information from which the interviewer motion information and the interviewee motion information are extracted, and stores them.

Then, in response to a request from the interviewer side such as the interviewer T, the information processing device 10 outputs the text information that is interviewer motion information and interviewee motion information associated with each other as described above, and the interview information including video information and audio information of the interviewee U of the part corresponding to such information (step S5).

As described above, according to the present embodiment, the interviewer motion information representing the motion such as speech of the interviewer T and the interviewee motion information representing the motion such as behavior of the interviewee U corresponding to the speech of the interviewer T are stored in association with each other. Therefore, the motion by the interviewee U corresponding to the motion of the interviewer T can be recognized, and evaluation information of the interviewee U related to such motion can be generated. As a result, it is possible to evaluate the interviewee U while taking into account how the interviewee interacts with another person. Further, by generating evaluation information in which motion of the interviewee is expressed in text, it is easy to objectively evaluate the interviewee. Even in the case of conducting a remote interview, it is possible to evaluate appropriately.

### Second Exemplary Embodiment

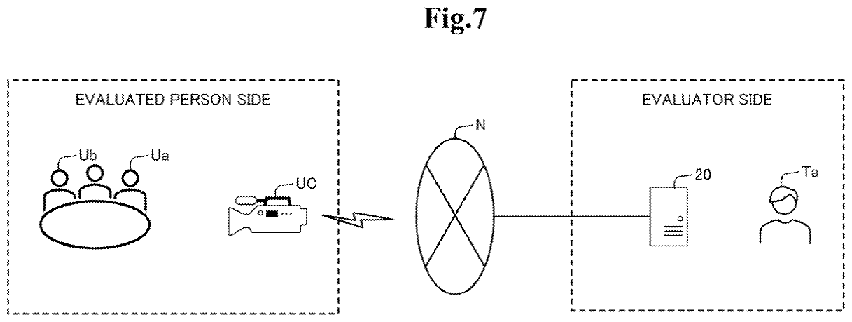

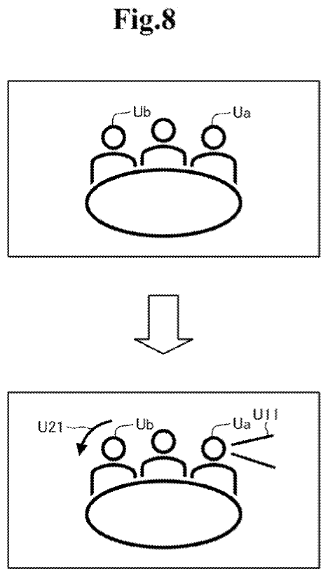

Next, a second exemplary embodiment of the present invention will be described with reference to FIGS. 7 and 8. An information processing system according to the second exemplary embodiment is a system for generating evaluation information including speech and motion information of a person to be evaluated while taking into account speech and motion of surrounding persons, when there are other persons around a specific person to be evaluated in a situation where a meeting such as a conference or a group discussion is conducted by a plurality of persons, as illustrated on the evaluated person side in FIG. 7. Here, the case of generating evaluation information for evaluating an evaluated person Ub to be evaluated, among a plurality of persons Ua and Ub illustrated in FIG. 7, will be described. However, the evaluated person Ub is not limited to one person, and may be a plurality of persons.

As illustrated in FIG. 7, the information processing system includes an imaging device such as a camera UC that acquires video information and audio information of a meeting conducted by a plurality of persons Ua and Ub on the evaluated person side, and an information processing device 20 connected to the camera UC over a network N. The information processing device 20 is installed on the evaluator side where am evaluator Ta exists, and has a configuration similar to that of the information processing device described in the first exemplary embodiment. That is, the information processing device 20 includes the acquisition unit 11, the generation unit 12, the output unit 13, the motion information storage unit 14, and the evaluation information storage unit storage unit 15, similar to the information processing device 10 as illustrated in FIG. 2. Hereinafter, regarding the constituent elements of the information processing device 20 of the present embodiment, the functions that are different from those of the first exemplary embodiment will be mainly described.

The acquisition unit 11 of the information processing device 20 according to the present embodiment acquires video information of a meeting, including audio information, captured by the camera UC. Then, the acquisition unit 11 analyzes the acquired video information, acquires motion information specifying the motion of the persons Ua and Ub on the evaluated person side, and stores the motion information in association with the video information. For example, the acquisition unit 11 analyzes the audio information spoken by the the person Ua (person other than the evaluated person) included in the video information, and acquires text information representing the words spoken by the person Ua as first person motion information. Further, the acquisition unit 11 analyzes the body motion, that is, behavior, of the person Ub to be evaluated included in the video information, and acquires text information specifying the motion of the person Ub to be evaluated as second person motion information. Note that the acquisition unit 11 may acquire text information specifying the motion of the person Ua as the first person motion information.

The generation unit 12 of the information processing device 20 according to the present embodiment extracts pieces of information corresponding to each other from the first person motion information and the second person motion information stored in the motion information storage unit 14, associates them with each other, and stores them in the evaluation information storage unit 15. At that time, first, from the first person motion information, the generation unit 12 extracts a piece of the first person motion information corresponding to a previously set motion. For example, from the first person motion information, the generation unit 12 extracts a piece of the first person motion information consisting of text including specific words. As an example, as the first person motion information, the generation unit 12 extracts first person motion information consisting of a series of sentence before the words “I think . . . ”. Then, the generation unit 12 extracts the second person motion information specifying a motion of the person Ub to be evaluated, corresponding to the motion of the person Ua represented by the extracted first person motion information. For example, the generation unit 12 specifies time information at which the motion of the person Ua represented by the extracted first person motion information was performed, and extracts the second person motion information specifying the motion of the person Ub to be evaluated performed immediately after such time. As an example, a motion “tilt his/her head” is extracted as the second person motion information.

Then, the generation unit 12 stores evaluation information in which the extracted first person motion information and second person motion information are associated with each other, in the evaluation information storage unit 15. At that time, the generation unit 12 stores the first person motion information and the second person motion information in association with the time information specifying a part in the video information including audio information from which the first person motion information and the second person motion information are extracted. Thereby, the video information and the extracted first person motion information and second person motion information are associated with each other. As described above, when the first person motion information acquired by the acquisition unit 11 is text information representing the motion of the person Ua as described above, the text representing the motion of the person Ua is associated with the corresponding second person motion information.

The output unit 13 of the information processing device 20 according to the present embodiment performs control to output information stored in the evaluation information storage unit 15 from an information processing terminal operated by the evaluator Ta on the evaluator side. For example, the output unit 13 outputs video information of the person Ub to be evaluated corresponding to the time information stored in the evaluation information storage unit, and text information that is the first person motion information and the second person motion information associated with such video information to display them on the same screen. As a result, the evaluator Ta can obtain information representing a motion (behavior) of the person Ub to be evaluated who is another person, when the person Ua in a meeting speaks or performs any motion, and such information can be used for evaluating the person Ub.

As described above, according to the present invention, the first person motion information representing a motion such as speech of the person Ua and the second person motion information representing a motion such as behavior of the person Ub to be evaluated corresponding to the speech of the person Ua are stored in association with each other. Therefore, it is possible to recognize a motion of the person Ub to be evaluated corresponding to the motion of the person Ua, and to acquire such motion as evaluation information of the person Ub to be evaluated. As a result, it is possible to evaluate the person Ub who is an evaluated person while taking into account how the person interacts with another person, and even for a person conducting a remote meeting, it is possible to evaluate appropriately. In particular, in the present invention, by generating evaluation information in which a motion of the person Ub to be evaluated corresponding to a motion of another person Ua is expressed in text, it is possible to easily evaluate the person Ub objectively.

Note that a process of extracting speech and motion information of the persons Ua and Ub from the video information and the audio information by the acquisition unit 11 and a process of generating evaluation information by the generation unit 12 may be performed by using video information and audio information that are previously acquired and stored. That is, the information processing device 20 is not necessarily perform a process of extracting speech and motion information and a process of generating evaluation information at real time during a meeting, but may analyze video data and audio data related to the recoded video of the meeting after the meeting to extract the speech and motion information and generate evaluation information. Further, even in the interview scene described in the first exemplary embodiment, it is possible to store interview information including video information and audio information at the time of interview, and analyze the stored interview information after the interview to extract speech and motion information and generate evaluation information.

### Third Exemplary Embodiment

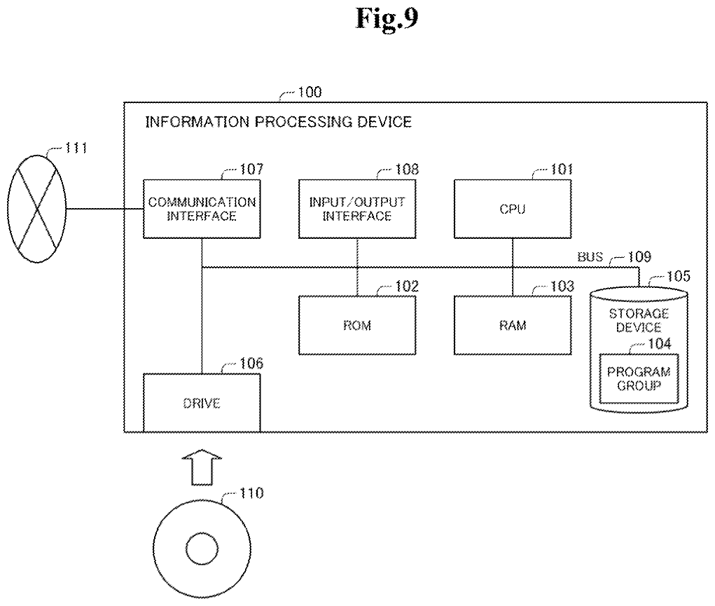

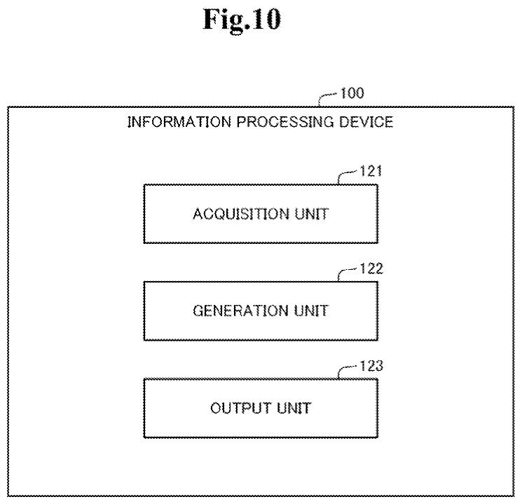

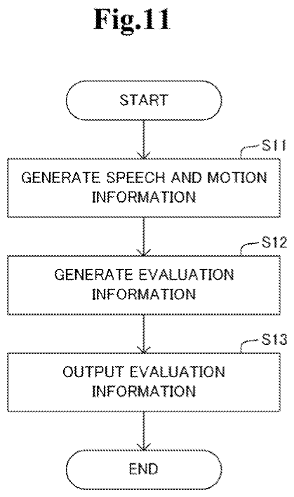

Next, a third exemplary embodiment of the present invention will be described with reference to FIGS. 9 to 11. FIGS. 9 and 10 are block diagrams illustrating a configuration of an information processing device according to the third exemplary embodiment, and FIG. 11 is a flowchart illustrating an operation of the information processing device. Note that the present embodiment shows the outlines of the configuration of the information processing device described in the embodiment described above.

First, a hardware configuration of an information processing device 100 of the present embodiment will be described with reference to FIG. 9. The information processing device 100 is configured of a typical information processing device, having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the respective constituent elements

The information processing device 100 can construct, and can be equipped with, an acquisition unit 121, a generation unit 122, and an output unit 123 illustrated in FIG. 10 through acquisition and execution of the program group 104 by the CPU 101. Note that the program group 104 is stored in the storage device 105 or the ROM 102 in advance, and is loaded to the RAM 103 and executed by the CPU 101 as needed. Further, the program group 104 may be provided to the CPU 101 via the communication network 111, or may be stored on the storage medium 110 in advance and read out by the drive 106 and supplied to the CPU 101. However, the acquisition unit 121, the generation unit 122, and the output unit 123 may be constructed by dedicated electronic circuits for implementing such means.

Note that FIG. 9 illustrates an example of the hardware configuration of an information processing device that is the information processing device 100. The hardware configuration of the information processing device is not limited to that described above. For example, the information processing device may be configured of part of the configuration described above, such as without the drive 106.

The information processing device 100 executes the information processing method illustrated in the flowchart of FIG. 11, by the functions of the acquisition unit 121, the generation unit 122, and the output unit 123 constructed by the program as described above.

As illustrated in FIG. 11, the information processing device 100 executes processing to

acquire video data and audio data related to a plurality of persons, and generate speech and motion information related to the plurality of persons on the basis of video data and audio data of each of the plurality of the persons (step S11),

generate evaluation information in which speech and motion information acquired from at least one person to be evaluated and speech and motion information acquired from at least another one of the persons, among the speech and motion information of the plurality of persons, are associated with each other (step S12), and

output the evaluation information (step S13).

Since the present invention is configured as described above, motion information based on the motion of a person to be evaluation and motion information based on the motion of another person are stored in association with each other. Therefore, it is possible to recognize the motion of a person to be evaluated corresponding to the motion of another person. As a result, it is possible to evaluate a person who is an evaluated person while taking into account how the person interacts with another person, and even for a person conducting a remote meeting, it is possible to evaluate appropriately.

Note that the program described above can be supplied to a computer by being stored in a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), a flash ROM, and a RAM (Random Access Memory)). The program may be supplied to a computer by various types of transitory computer-readable media. Examples of transitory computer-readable media include electric signals, optical signals, and electromagnetic waves. A transitory computer-readable medium can supply a program to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art. Further, at least one of the functions of the acquisition unit 121, the generation unit 122, and the output unit 123 described above may be carried out by an information processing device provided and connected to any location on the network, that is, may be carried out by so-called cloud computing.

### <Supplementary Notes>

The whole or part of the exemplary embodiments disclosed above can be described as the following supplementary notes. Hereinafter, outlines of a person evaluation information generation method, a person evaluation information generation device, and a program of the present invention will be described. However, the present invention is not limited to the following configurations.

### (Supplementary Note 1)

A person evaluation information generation method comprising:

acquiring video data and audio data related to a plurality of persons;

generating speech and motion information related to the plurality of persons on a basis of the video data and the audio data of each of the plurality of persons;

generating evaluation information in which speech and motion information acquired from at least one person to be evaluated and speech and motion information acquired from at least another person, among the speech and motion information of the plurality of persons, are associated with each other; and

outputting the evaluation information.

### (Supplementary Note 2)

The person evaluation information generation method according to supplementary note 1, further comprising

generating the evaluation information in which speech and motion information related to a motion of the person to be evaluated, generated from video data in which the person to be evaluated is captured, and the speech and motion information of the other person are associated with each other.

### (Supplementary Note 3)

The person evaluation information generation method according to supplementary note 2, further comprising

generating the evaluation information in which speech and motion information represented by text related to the motion of the person to be evaluated, acquired from the video data, and the speech and motion information of the other person are association with each other.

### (Supplementary Note 4)

The person evaluation information generation method according to supplementary note 2 or 3, further comprising

generating the evaluation information in which speech and motion information based on a preset motion of the other person and speech and motion information specifying a motion of the person to be evaluated corresponding to the motion represented by the speech and motion information of the other person are associated with each other.

### (Supplementary Note 5)

The person evaluation information generation method according to any of supplementary notes 2 to 4, further comprising

generating the evaluation information in which the speech and motion information of the person to be evaluated, associated with the speech and motion information of the other person, and the video data at a time of the motion of the person to be evaluated, specified by the speech and motion information of the person to be evaluated, are associated with each other.

### (Supplementary Note 6)

The person evaluation information generation method according to supplementary note 5, further comprising

outputting the speech and motion information of the person to be evaluated and the video data associated with each other, in association with each other.

### (Supplementary Note 7)

The person evaluation information generation method according to any of supplementary notes 1 to 6, wherein

the evaluation information includes an evaluation result of the person to be evaluated.

### (Supplementary Note 8)

The person evaluation information generation method according to any of supplementary notes 1 to 7, wherein

the person to be evaluated is an interviewee.

### (Supplementary Note 9)

A person evaluation information generation device comprising:

an acquisition unit that acquires video data and audio data related to a plurality of persons, and generates speech and motion information related to the plurality of persons on a basis of the video data and the audio data of each of the plurality of persons;

a generation unit that generates evaluation information in which speech and motion information acquired from at least one person to be evaluated and speech and motion information acquired from at least another person, among the speech and motion information of the plurality of persons, are associated with each other; and

an output unit that outputs the evaluation information.

### (Supplementary Note 10)

The person evaluation information generation device according to supplementary note 9, wherein

the generation unit generates the evaluation information in which speech and motion information related to a motion of the person to be evaluated, acquired from video data in which the person to be evaluated is captured, and the speech and motion information of the other person are associated with each other.

### (Supplementary Note 11)

The person evaluation information generation device according to supplementary note 10, wherein

the generation unit generates the evaluation information in which speech and motion information represented by text related to the motion of the person to be evaluated, acquired from the video data, and the speech and motion information of the other person are association with each other.

### (Supplementary Note 12)

The person evaluation information generation device according to supplementary note 10 or 11, wherein

the generation unit generates the evaluation information in which speech and motion information based on a preset motion of the other person and speech and motion information specifying a motion of the person to be evaluated corresponding to the motion represented by the speech and motion information of the other person are associated with each other.

### (Supplementary Note 13)

The person evaluation information generation device according to any of supplementary notes 10 to 12, wherein

the generation unit generates the evaluation information in which the speech and motion information of the person to be evaluated, associated with the speech and motion information of the other person, and the video data at a time of the motion of the person to be evaluated, specified by the speech and motion information of the person to be evaluated, are associated with each other.

### (Supplementary Note 14)

The person evaluation information generation device according to supplementary note 13, wherein

the output unit outputs the speech and motion information of the person to be evaluated and the video data associated with each other, in association with each other.

### (Supplementary Note 15)

A computer-readable medium storing thereon a program for causing an information processing device to execute processing to:

acquire video data and audio data related to a plurality of persons;

generate speech and motion information related to the plurality of persons on a basis of the video data and the audio data of each of the plurality of persons;

generate evaluation information in which speech and motion information acquired from at least one person to be evaluated and speech and motion information acquired from at least another person, among the speech and motion information of the plurality of persons, are associated with each other; and

output the evaluation information.

### (Supplementary Note 16)

A person evaluation information generation method comprising:

extracting interviewer information related to speech and motion of an interviewer from video data and/or audio data in which the interviewer and an interviewee are captured;

extracting interviewee information related to speech and motion of the interviewee with respect to the speech and motion of the interviewer corresponding to the interviewer information; and

on a basis of the interviewer information and the interviewee information, generating evaluation information for evaluating the interviewee.

### REFERENCE SIGNS LIST

20 information processing device
11 acquisition unit
12 generation unit
13 output unit
14 motion information storage unit
15 evaluation information storage unit
T interviewer
TT interviewer terminal
U interviewee
UT interviewee terminal
100 information processing device
101 CPU
102 ROM
103 RAM
104 program group
105 storage device
106 drive
107 communication interface
108 input/output interface
109 bus
110 storage medium
111 communication network
121 acquisition unit
122 generation unit
123 output unit

What is claimed is:

1. A person evaluation information generation method comprising:
acquiring video data and audio data related to a plurality of persons;
generating speech and motion information related to the plurality of persons on a basis of the video data and the audio data of each of the plurality of persons;
generating evaluation information on a basis of speech and motion information of at least one person to be evaluated and speech and motion information of at least another person, among the speech and motion information of the plurality of persons; and
outputting the evaluation information.

2. The person evaluation information generation method according to claim 1, further comprising
generating the evaluation information in which speech and motion information related to a motion of the person to be evaluated, generated from video data in which the person to be evaluated is captured, and the speech and motion information of the other person are associated with each other.

3. The person evaluation information generation method according to claim 2, further comprising
generating the evaluation information in which speech and motion information represented by text related to the motion of the person to be evaluated, acquired from the video data, and the speech and motion information of the other person are association with each other.

4. The person evaluation information generation method according to claim 2, further comprising
generating the evaluation information in which speech and motion information based on a preset motion of the other person and speech and motion information specifying a motion of the person to be evaluated corresponding to the motion represented by the speech and motion information of the other person are associated with each other.

5. The person evaluation information generation method according to claim 2, to further comprising
generating the evaluation information in which the speech and motion information of the person to be evaluated, associated with the speech and motion information of the other person, and the video data at a time of the motion of the person to be evaluated, specified by the speech and motion information of the person to be evaluated, are associated with each other.

6. The person evaluation information generation method according to claim 5, further comprising
outputting the speech and motion information of the person to be evaluated and the video data associated with each other, in association with each other.

7. The person evaluation information generation method according to claim 1, wherein
the evaluation information includes an evaluation result of the person to be evaluated.

8. The person evaluation information generation method according to claim 1, wherein
the person to be evaluated is an interviewee.

9. A person evaluation information generation device comprising:
at least one memory configured to store instructions; and
at least one processor configured to execute instructions to:
acquire video data and audio data related to a plurality of persons, and generate speech and motion information related to the plurality of persons on a basis of the video data and the audio data of each of the plurality of persons;
generate evaluation information in which speech and motion information of at least one person to be evaluated and speech and motion information acquired from at least another person, among the speech and motion information of the plurality of persons, are associated with each other; and
output the evaluation information.

10. The person evaluation information generation device according to claim 9, wherein the at least one processor is configured to execute the instructions to
generate the evaluation information in which speech and motion information related to a motion of the person to be evaluated, acquired from video data in which the person to be evaluated is captured, and the speech and motion information of the other person are associated with each other.

11. The person evaluation information generation device according to claim 10, wherein the at least one processor is configured to execute the instructions to
generate the evaluation information in which speech and motion information represented by text related to the motion of the person to be evaluated, acquired from the video data, and the speech and motion information of the other person are association with each other.

12. The person evaluation information generation device according to claim 10, wherein the at least one processor is configured to execute the instructions to
generate the evaluation information in which speech and motion information based on a preset motion of the other person and speech and motion information specifying a motion of the person to be evaluated corresponding to the motion represented by the speech and motion information of the other person are associated with each other.

13. The person evaluation information generation device according to claim 10, wherein the at least one processor is configured to execute the instructions to
generate the evaluation information in which the speech and motion information of the person to be evaluated, associated with the speech and motion information of the other person, and the video data at a time of the motion of the person to be evaluated, specified by the speech and motion information of the person to be evaluated, are associated with each other.

14. The person evaluation information generation device according to claim 13, wherein the at least one processor is configured to execute the instructions to
output the speech and motion information of the person to be evaluated and the video data associated with each other, in association with each other.

15. A non-transitory computer-readable medium storing thereon a program comprising instructions for causing an information processing device to execute processing to:
acquire video data and audio data related to a plurality of persons;
generate speech and motion information related to the plurality of persons on a basis of the video data and the audio data of each of the plurality of persons;
generate evaluation information in which speech and motion information acquired from at least one person to be evaluated and speech and motion information acquired from at least another person, among the speech and motion information of the plurality of persons, are associated with each other; and
output the evaluation information.

16. (canceled)
